(19) United States
(12) Patent Application Publication
(10) Pub. No.: US 2025/0311065 A1
(43) Pub. Date: Oct. 2, 2025

(54) AEROSOL PRODUCT HEATING ASSEMBLY AND AEROSOL GENERATION DEVICE

(71) Applicant: SHENZHEN FIRST UNION TECHNOLOGY CO., LTD., Shenzhen, Guangdong (CN)

(72) Inventors: Zhiming LU, Shenzhen, Guangdong (CN); Ruilong HU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/856,172

(22) PCT Filed: Apr. 27, 2023
(86) PCT No.: PCT/CN2023/091128

§ 371 Date: Oct. 11, 2024

(30) Foreign Application Priority Data
Apr. 28, 2022 (CN) 202221044855.0

(51) Int. Cl. H05B 6/10; A24F 40/465

(52) U.S. Cl. CPC H05B 6/108; A24F 40/465

(57) ABSTRACT

An aerosol product heating assembly and an aerosol generation device are provided. The aerosol product heating assembly heats an aerosol product to generate aerosols. The heating assembly includes: a heating chamber configured to accommodate an aerosol product and cause the aerosol product to be heated in the heating chamber; and a flexible clamping member provided with an extending portion that at least partially extends into the heating chamber. The extending portion forms a first through hole in the heating chamber. The extending portion is provided with at least one second through hole adjacent to the first through hole. When the aerosol product is accommodated in the heating chamber, the aerosol product penetrates through the first through hole and is circumferentially clamped by a hole wall of the first through hole. External air enters the heating chamber through the second through hole.

### CROSS-REFERENCE TO RELATED APPLICATIONS

This application claims priority to Chinese Application No. 202221044855.0, filed with the China National Intellectual Property Administration on Apr. 28, 2022 and entitled “AEROSOL PRODUCT HEATING ASSEMBLY AND AEROSOL GENERATION DEVICE”, which is incorporated herein by reference in its entirety.

### TECHNICAL FIELD

Embodiments of this application relate to the technical field of aerosol, and in particular, to an aerosol product heating assembly and an aerosol generation device.

### BACKGROUND

At present, there are mainly two types of electronic cigarette devices on the market, such as an atomized cigarette that generates inhalable aerosols by evaporating e-liquid and a low-temperature cigarette that generates inhalable aerosols by heating/distilling tobacco materials at a low temperature (150 to 300° C.). Compared with a traditional burning type cigarette, the atomized cigarette and the low-temperature cigarette have a low working temperature. Harmful components in e-liquid used in the atomized cigarette or in aerosols generated by the low-temperature cigarette are far less than harmful components generated by the traditional burning type cigarette. Therefore, using the atomized cigarette or the low-temperature cigarette can greatly avoid adverse impact of cigarettes on the health of a human.

Common low-temperature cigarettes on the market are generally classified into a central heating type and a surrounded heating type, a general structure of each of which is as follows: A cigarette placement path is arranged in a cigarette device. A heating body is located in the cigarette placement path (central heating type). When heating a cigarette, the heating body needs to be inserted into the cigarette. Or, the heating body is located around the cigarette placement path (surrounding heating type). To heat a cigarette, the heating body needs to be located around the cigarette (i.e. the cigarette is placed into the heating body). During use, power is supplied to the heating body to generate heat, to heat the low-temperature cigarette in the cigarette placement path. For these traditional low-temperature cigarettes, a clamping structure for clamping the cigarette, such as a flexible silica gel claw or a hard plastic claw, is usually arranged in the cigarette placement pa. A clamping force on a surface of the cigarette is not uniform, so that the clamping claw easily causes indentations on the surface of the cigarette. When the cigarette is pulled out, residues easily fall out.

### SUMMARY

For the above technical problems, some embodiments of this application provide an aerosol product heating assembly and an aerosol generation device, to solve the technical problem: When an aerosol product is accommodated in the aerosol product heating assembly at present, a clamping force on an outer surface of the aerosol product is not uniform, and indentations are easily generated.

An aerosol product heating assembly is configured to heat an aerosol product to generate aerosols. The heating assembly includes:
a heating chamber, configured to accommodate the aerosol product and cause the aerosol product to be heated in the heating chamber; and
a flexible clamping member, provided with an extending portion that at least partially extends into the heating chamber, the extending portion forming a first through hole in the heating chamber, the extending portion being provided with at least one second through hole adjacent to the first through hole;
wherein when the aerosol product is accommodated in the heating chamber, the aerosol product penetrates through the first through hole and is circumferentially clamped by a hole wall of the first through hole; and external air enters the heating chamber through the second through hole.

In one of the embodiments, a plurality of second through holes are included; and the plurality of second through holes surround the first through hole.

In one of the embodiments, the heating chamber is provided with an opening end for allowing the aerosol product to enter the heating chamber; and the flexible clamping member is mounted at the opening end.

In one of the embodiments, the heating assembly includes a first end cap and a second end cap which are oppositely arranged in an axial direction, and a heating pipe supported between the first end cap and the second end cap; the first end cap and the heating pipe are hollowed; hollow portions of the first end cap and the heating pipe are communicated to form at least one portion of the heating chamber; the opening end is formed by the first end cap; and the flexible clamping member is mounted on the first end cap.

In one of the embodiments, the second end cap includes a bottom wall and a resisting portion that extends axially from the bottom wall towards the heating pipe; and the resisting portion includes an end surface configured to resist against the aerosol product.

In one of the embodiments, the resisting portion includes a side wall that extends axially between the end surface and the bottom wall; at least one groove is provided in the side wall; and the groove is configured to guide the external air entering the heating chamber into the aerosol product.

In one of the embodiments, the resisting portion is configured to be of a hollow structure; the end surface of the resisting portion is opened; and the hollow structure is configured to collect residues falling from the aerosol product.

In one of the embodiments, the groove is communicated to the hollow region of the resisting portion.

In one of the embodiments, a thickness of the extending portion gradually decreases in an extending direction.

In one of the embodiments, a hole wall of the first through hole has a thickness of 0.2 to 0.4 mm.

In one of the embodiments, the aerosol product is configured as a cylindrical body; a hole diameter of the first through hole is less than an outer diameter of the aerosol product by 0.01 to 1 mm.

The embodiments of this application further provide an aerosol generation device. The aerosol generation device includes the above heating assembly, and a power supply mechanism configured to supply electric energy to the heating assembly.

According to the aerosol product heating assembly provided in this embodiment of this application, by providing the flexible clamping member in the heating assembly, the flexible clamping member at least partially extends into the heating chamber; and the first through hole and the second through holes adjacent to the first through holes are formed in the heating chamber. When the aerosol product is accommodated in the heating chamber, a hole wall of the first through hole can clamp the aerosol product in a circumferential direction, and a gap between the hole wall of the first through hole and an outer surface of the aerosol product is sealed. Meanwhile, external air can enter the heating chamber through the second through holes. The hole wall of the first through hole clamps the aerosol product in the circumferential direction. Compared with an existing clamping mode using a clamping claw, the circumferential clamping can apply a uniform clamping force to the outer surface of the aerosol product, so that indentations are not easily generated on the outer surface of the aerosol, and it is not easy for cigarette residues to fall out.

### BRIEF DESCRIPTION OF THE DRAWINGS

One or more embodiments are exemplarily described with reference to the accompanying drawings, and these exemplary descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic three-dimensional diagram of an aerosol product heating assembly provided in an embodiment of this application in a direction;

FIG. 2 is a schematic cross-sectional diagram of the aerosol product heating assembly in FIG. 1 in a direction;

FIG. 3 is an exploded diagram of the aerosol product heating assembly in FIG. 1 in a viewing angle;

FIG. 4 is a schematic cross-sectional diagram of a smoking product adapted to the aerosol product heating assembly in FIG. 1 in a direction;

FIG. 5 is a schematic three-dimensional diagram of a first end cap of the aerosol product heating assembly in FIG. 3 in a direction;

FIG. 6 is a schematic three-dimensional diagram of the first end cap in FIG. 5 in another direction;

FIG. 7 is a schematic three-dimensional diagram of a flexible clamping member of the aerosol product heating assembly in FIG. 3 in a direction;

FIG. 8 is a schematic three-dimensional diagram of a first seal member of the aerosol product heating assembly in FIG. 3 in a direction;

FIG. 9 is a schematic cross-sectional diagram of the flexible clamping member in FIG. 7 in a direction;

FIG. 10 is a schematic three-dimensional diagram of a second end cap of the aerosol product heating assembly in FIG. 3 in a direction;

FIG. 11 is a schematic cross-sectional diagram when an aerosol product is accommodated in an aerosol product heating assembly.

### DETAILED DESCRIPTION

For ease of understanding of this application, this application is described below in more detail with reference to the accompanying drawings and specific embodiments. It should be noted that, when an element is expressed as “being fixed to”/“being fixedly connected to” another element, the element may be directly on the another element, or one or more intermediate elements may exist between the element and the another element. When one element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. Terms used in the specification of this application are merely intended to describe objectives of the specific embodiments, but are not intended to limit this application. A term “and/or” used in this specification includes any or all combinations of one or more related listed items.

In addition, technical features involved in different embodiments of this application described below may be combined if there is no conflict.

In the embodiments of this application, the term “mount” including welding, screwing, clamping, bonding, and the like is used to fix or restrict an element or device to a specific position or place. The element or device can remain stationary in the specific position or place or move within a limited range. After being fixed or restricted to the specific position or place, the element or device can be removed or not be removed. This embodiment of this application does not impose any limitation.

In addition, terms “first” and “second” are used merely for the purpose of description, and shall not be construed as indicating or implying relative importance or implying a quantity of indicated technical features. Therefore, a feature limited by “first” or “second” may explicitly or implicitly include one or more of the features. In description of this application, “multiple” means at least two, such as two and three unless it is specifically defined otherwise.

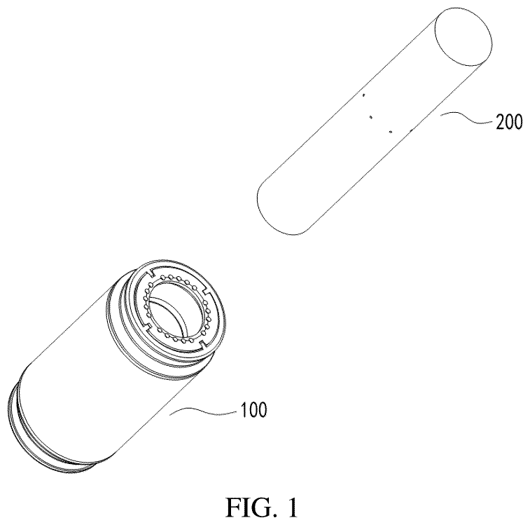

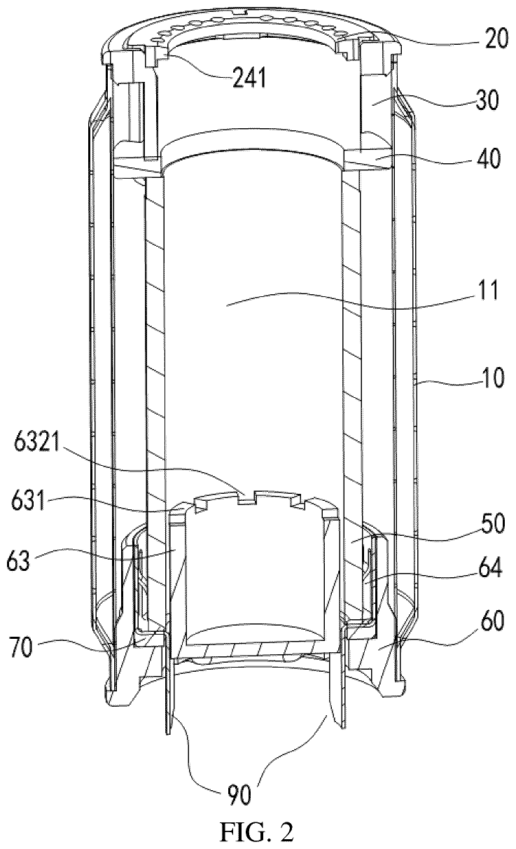

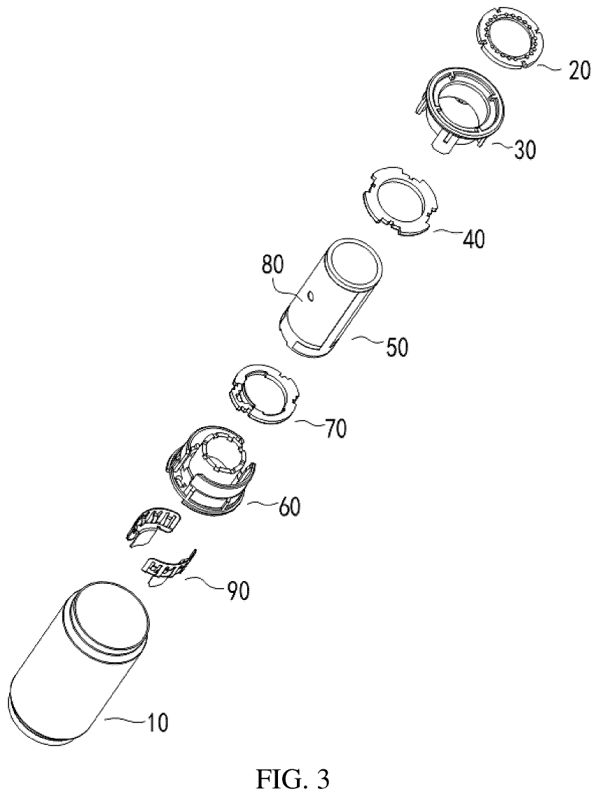

Referring to FIG. 1 to FIG. 3. FIG. 1 to FIG. 3 respectively show a schematic three-dimensional diagram and schematic cross-sectional diagram in a direction and a schematic exploded diagram in a viewing angle of an aerosol product heating assembly 100 provided in an embodiment of this application. The heating assembly 100 is configured to accommodate an aerosol product 200 and heat the aerosol product 200 to cause at least a portion of volatile substances in the aerosol product 200 to evaporate under a heating condition, thereby producing aerosols that can be inhaled by a user. The aerosol product 200 is usually a cigarette-shaped smoking product filled with tobaccos that can evaporate and generate smoke or aerosols under the heating condition. Or, of course, other forms of active herbaceous plants, such as herbs, can fill the aerosol product 200. In this case, the aerosols generated by heating the aerosol product 200 to evaporate can be used to treat respiratory diseases. In this embodiment, the cigarette-shaped smoking product is taken as an example for explanation.

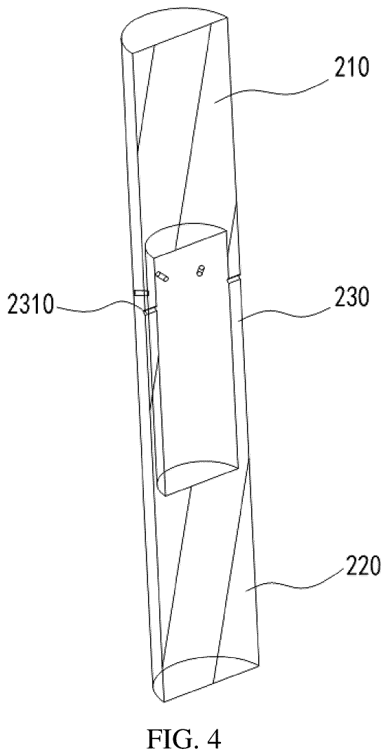

Continuing to refer to FIG. 4, FIG. 4 shows a schematic cross-sectional view of a smoking product 200 in a direction. The smoking product 200 is typically cylindrical, provided with a suction nozzle section 210 and a cut tobacco section 220 which are opposite to each other, and a cooling section 230 arranged between the suction nozzle section 210 and the cut tobacco section 220. The suction nozzle section 210 is filled with a filter (not shown), so that a user can directly puff on the suction nozzle section 210. The cut tobacco section 220 is filled with an active volatile substance such as tobaccos, which can evaporate and produce smoke when heated. The cooling section 230 is provided with an air intake vent 2310 for allowing external air to enter the smoking product 200. When a user puffs on the suction nozzle section 210, the external air can enter the smoking product 200 through the air intake vent 2310. The external air is mixed with high-temperature aerosols, which can effectively reduce the temperature of the high-temperature aerosols, so that the temperature of the aerosols inhaled by the user is appropriate. When the smoking product 200 is accommodated in the heating assembly 100, the suction nozzle section 210 is exposed out of the heating assembly 100, and the cut tobacco section 220 is accommodated in the heating assembly 100, to facilitate the heating assembly 100 to heat cut tobaccos.

The heating assembly 100 includes a housing 10, a flexible clamping member 20, a first end cap 30, a first seal member 40, a heating pipe 50, a second end cap 60, a second seal member 70, a heating element 80, and a conductive electrode 90. The housing 10 is a hollow cylindrical body provided with openings in two ends. The first end cap 30 and the second end cap 60 are respectively mounted from the two open ends of the housing 10 into the housing 10. The heating pipe 50 is supported on the second end cap 60 to heat the smoking product 200. The first seal member 40 is pressed between the heating pipe 50 and the first end cap 30 and is configured to seal an assembling gap between the heating pipe 50 and the first end cap 30. The flexible clamping member 20 is supported on the first end cap 30 and is configured to clamp the smoking product 200. The second seal member 70 is pressed between the heating pipe 50 and the second end cap 60 and is configured to seal an assembling gap between the heating pipe 50 and the second end cap 60. The heating element 80 is attached to an outer surface of heating pipe 50. The conductive electrode 90 is electrically connected to the heating element 80.

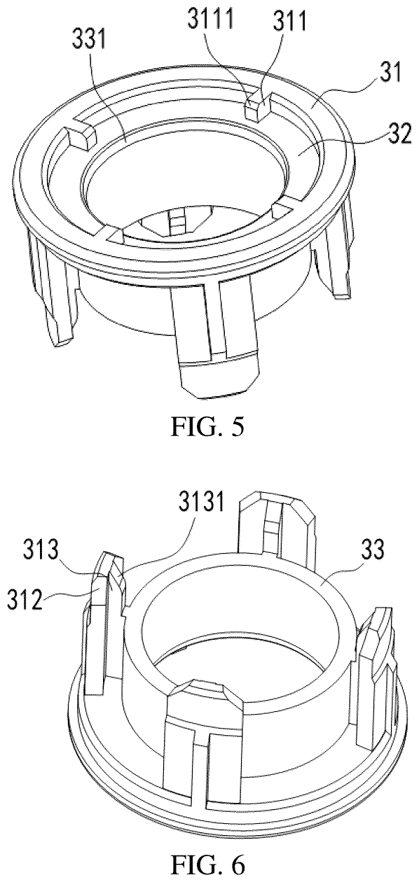

Continuing to refer to FIG. 5 and FIG. 6, FIG. 5 and FIG. 6 respectively show schematic three-dimensional diagrams of the first end cap 30 in two directions. The first end cap 30 includes an end surface 31 and supporting surface 32, as well as a hollow tubular body 33 that extends axially from the supporting surface 32 towards the heating pipe 50. The first end cap 30 further includes a connecting end surface 31 and a supporting surface 32, as well as a first boss structure 311 that extends radially towards the hollow tubular body 33. The first end cap 30 further includes an extending portion 312 that extends axially from the end surface 31 towards the heating pipe 50. A second boss structure 313 is formed on an inner wall of the extending portion 312. The first boss structure 311 and the second boss structure 313 are used as clamping portions to be clamped with the flexible clamping member 20 and the first seal member 40 respectively, to position the flexible clamping member 20 and the first seal member 40 in a circumferential direction and prevent the flexible clamping member 20 and the first seal member 40 from rotating.

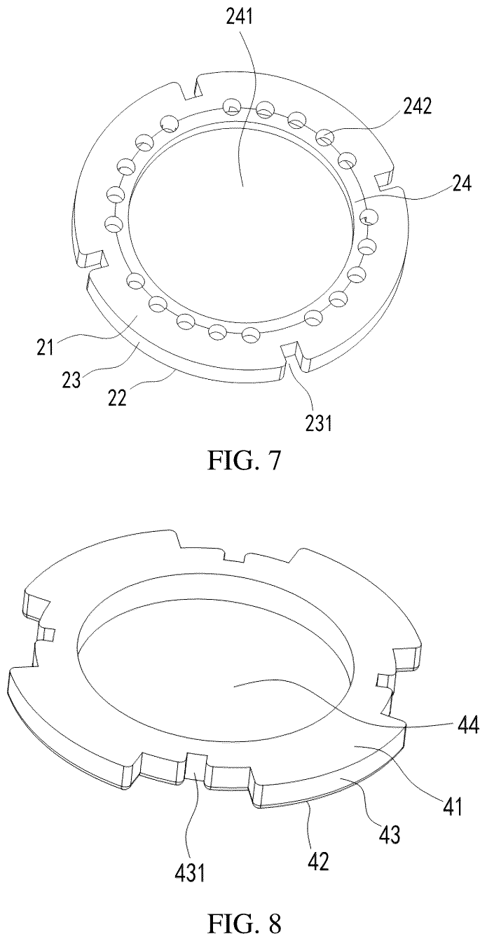

Continuing to refer to FIG. 7 and FIG. 8, FIG. 7 and FIG. 8 respectively show a schematic three-dimensional diagram of the flexible clamping member 20 in a direction and a schematic three-dimensional diagram of the first seal member 40 in a direction. The flexible clamping member 20 and the first seal member 40 are both made of elastic flexible rubber materials, such as silica gel or rubber. The flexible clamping member 20 is provided with a first end surface 21 and a second end surface 22 which are opposite to each other, as well as a side wall 23 that extends between the first end surface 21 and the second end surface 22. The first seal member 40 is also provided with a first end surface 41 and a second end surface 42 which are opposite to each other, as well as a side wall 43 that extends between the first end surface 41 and the second end surface 42. The first end cap 30 abuts against the first end surface 41 of the first seal member 40, and the heating pipe 50 abuts against the second end surface 42, so that the first seal member 40 provides sealing between the first end cap 30 and the heating pipe 50. A clamping slot 231 that extends axially is formed in the side wall 23 of the flexible clamping member 20, and a clamping slot 431 that extends axially is formed in the side wall 43 of the first seal member 40. The first boss structure 311 of the first end cap 30 is clamped in the clamping slot 231, and the second boss structure 313 is clamped in the clamping slot 431, so that the flexible clamping member 20 and the first seal member 40 are positioned in the circumferential direction, namely, the flexible clamping member 20 and the first seal member 40 cannot rotate in the circumferential direction.

In addition, to facilitate the clamping of the flexible clamping member 20 and the first seal member 40 to the first end cap 30 during mounting, the first boss structure 311 is formed with a first guide surface 3111, and the second boss structure 313 is formed with a second guide surface 3131. The first guide surface 3111 is configured to provide guidance when the flexible clamping member 20 is clamped to the first end cap 30, and the second guide surface 3131 is configured to provide guidance when the first seal member 40 is clamped to the first end cap 30. In addition, a guide surface 331 is further formed on an inner wall of the hollow tubular body 33. The guide surface 331 is configured to provide guidance when the aerosol product 200 extends into the hollow tubular body 33 of the first end cap 30, so that the aerosol product 200 can smoothly extend into the first end cap 30 and pass through the hollow tubular body 33 of the first end cap 30.

Continuing to refer to FIG. 7 and FIG. 8, the flexible clamping member 20 is provided with an extending portion 24 that extends radially towards an inner side. The extending portion 24 is annular, a boundary of which forms a first through hole 241. After mounting, the flexible clamping member 20 can extend into a heating chamber 11. A third through hole 44 that penetrates through the first end surface 41 and the second end surface 42 is formed in the first seal member 40. The heating pipe 50 is constructed as a hollow cylindrical body with openings in two ends. The first end surface 41 and second end surface 42 of the first seal member 40 are respectively pressed by the first end cap 30 and the heating pipe 50, so that the first seal member 40 is arranged between the first end cap 30 and the heating pipe 50, thereby communicating the first through hole 241 of the flexible clamping member 20, the hollow tubular body 33 of the first end cap 30, the third through hole 44 of the first seal member 40, and a hollow region of the heating pipe 50 to form the heating chamber 11. Therefore, the smoking product 200 can be inserted and accommodated into the heating assembly 100 through the heating chamber 11. The first through hole 241 is used as an open end of heating chamber 11 and is configured to provide an inlet for the smoking product 200 to enter the heating chamber 11. It is easily understood that the extending portion 24 may be formed by extending radially from the side wall 23 of the flexible clamping member 20.

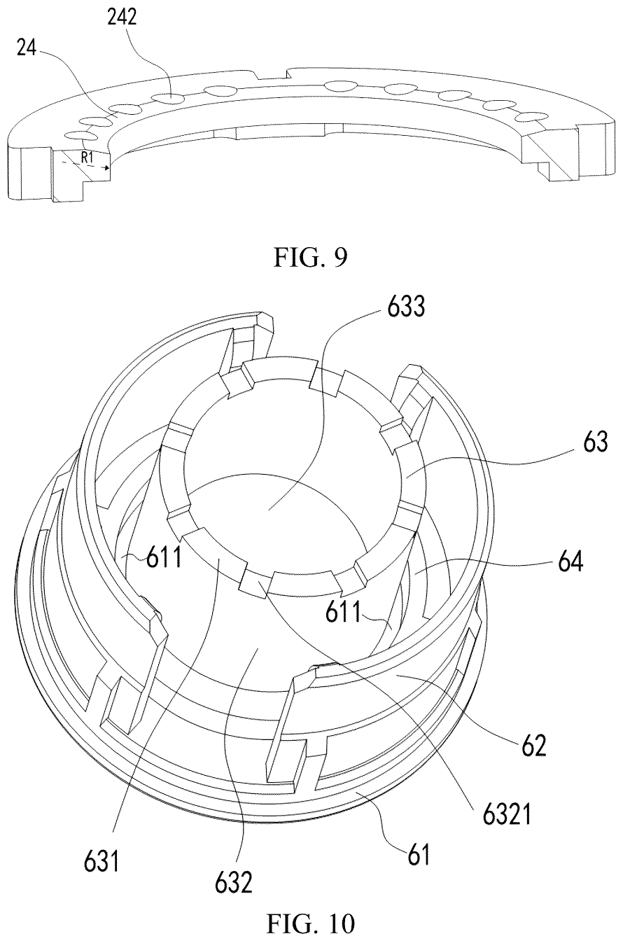

It is worth noting that a thickness of the extending portion 24 gradually decreases in an extending direction. Namely, a thickness of an extension start position of the extending portion 24 is greater than a thickness of the hole wall of the first through hole 241. The larger thickness at the extension start position can make the connection strength of the extending portion 24 higher. The thickness gradually decreases in the extending direction, which can make the thickness of the hole wall of the first through hole 241 smaller, so that the smoking product 200 can pass through the first through hole 241 more smoothly, and the pressure from the hole wall of the first through hole 241 to the smoking product 200 can be reduced. In FIG. 9, R1 shows an indication path where the thickness gradually decreases.

When the smoking product 200 is accommodated in the heating assembly 100 through the heating chamber 11, the smoking product 200 may first enter the hollow tubular body 33 of the first end cap 30 through the first through hole 241, and then enter the heating pipe 50 through the third through hole 44 from the hollow tubular body 33 of the first end cap 30. It is worth noting that a hole diameter of the first through hole 241 is slightly less than an outer diameter of the smoking product 200. Therefore, when the smoking product 200 passes through the first through hole 241, a surface of the smoking product 200 will press the hole wall of the first through hole 241 in the circumferential direction, causing the flexible clamping member 20 to deform. Since the flexible clamping member 20 has elasticity, under the action of elastic restoring force, the hole wall of the first through hole 241 will exert reverse pressure on the surface of the smoking product 200. Under the action of the reverse pressure, the hole wall of the first through hole 241 tightly clamps the smoking product 200 in the circumferential direction, making it difficult to pull out the smoking product 200 when it is accommodated in the heating assembly 100, thereby effectively avoiding the lip of a user from bringing out the smoking product 200 during smoking. Meanwhile, since the hole wall of the first through hole 241 clamps the smoking product 200 in the circumferential direction, a clamping force on the smoking product 200 in the circumferential direction is uniform, and indentations are not easily generated on the surface of the smoking product 200.

It should be noted that, since an outer surface of the smoking product 20 is usually made of a paper material, if the clamping force applied by flexible clamping member 20 to the smoking product 200 is too low, it is easy for the flexible clamping member 20 to loosely clamp the smoking product 200, and the smoking product 200 is easily pulled out by the lip of a user during smoking. If the clamping force applied by the flexible clamping member 20 to the smoking product 200 is too high, it is easy to generate creases on the outer surface of the smoking product 200, so that indentations are generated on the outer surface of the smoking product 200. To provide the flexible clamping member 20 with appropriate deformation, making the clamping force applied by the flexible clamping member 20 to the smoking product 20 appropriate, preferably, the thickness of the hole wall of the first through hole 241 of the flexible clamping member 20 is set within a range of 0.2 to 0.4 mm. The hole diameter of the first through hole 241 is greater than the outer diameter of the smoking product 200 by 0.01 to 1 mm. When the thickness of the hole wall of and the hole diameter of the first through hole 241 are within this range, the clamping force applied by the flexible clamping member 20 to the smoking product 200 is relatively appropriate.

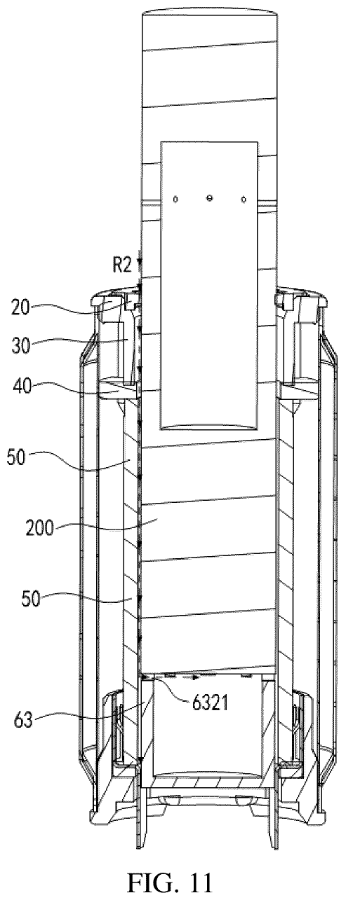

Further, continuing to refer to FIG. 7 and referring to FIG. 11 in conjunction, as the flexible clamping member 20 is made of a flexible material and the flexible clamping member 20 clamps the smoking product 200 in the circumferential direction, sealing is generated between the hole wall of the first through hole 241 and the outer surface of the smoking product 200, and the external air cannot enter the heating chamber 11 through the hole wall of the first through hole 241 and the outer surface of the smoking product 200. Therefore, to enable the external air to enter the heating chamber 11, the extending portion 24 of the flexible clamping member 20 is provided with a plurality of second through holes 242 that surround the first through hole 241. A hole diameter of each second through hole 242 is less than that of the first through hole 241. The external air can enter the heating chamber 11 through the second through holes 241 and flow along a gap between the outer surface of the smoking product 200 and the inner wall of the heating chamber 11 to the cut tobacco section 220 of the smoking product 200.

It should be noted that, in other embodiments of this application, only one second through hole 242 may be provided, as long as the external air can enter the heating chamber 11 through the second through hole 242. In this embodiment, the plurality of second through holes 242 that surround the first through hole 241 are provided. On the one hand, the external air can enter the heating chamber 11 through the plurality of second through holes 242 more smoothly. On the other hand, since these second through holes 242 surround the first through hole 241 nearby, the connection strength of the hole wall of the first through hole 241 can be reduced, and the clamping force applied by the hole wall of the first through hole 241 to the smoking product 200 is further reduced, thereby effectively reducing the indentations on the outer surface of the smoking product 200.

Continuing to refer to FIG. 10, FIG. 10 shows a schematic three-dimensional diagram of the second end cap 60 in a direction. The second end cap 60 includes a bottom wall 61 and an outer wall 62 that extends axially from the bottom wall 61 to the heating pipe 50, as well as a resisting portion 63 that extends axially from the bottom wall 61 towards the heating pipe 50. The resisting portion 63 includes an end surface 631 opposite to the bottom wall 61, and a side wall 632 that extends between the end surface 631 and the bottom wall 61. After mounting, the resisting portion 63 of the second end cap 60 extends into the heating pipe 50, so that when the smoking product 200 is accommodated in the heating chamber 11, the smoking product 200 resists against the end surface 631 of the resisting portion 63 to limit the smoking product 200 at a proper position in the heating chamber 11, which facilitates a user to smoke with a suction nozzle end 210 of the smoking product 200.

Further, to facilitate guiding the external air that enters the heating chamber 11 into the smoking product 200, at least one groove 6321 is provided in the side wall 632 of the resisting portion 63 by radially extending along the end surface 631. Meanwhile, the resisting portion 63 is constructed as a hollow tubular structure. The resisting portion 63 is provided with a hollow region 633. The end surface 631 of the resisting portion 63 is constructed as being opened. The groove 6321 is in fluid communication with the hollow region 633 of the resisting portion 63. Therefore, after the external air enters the heating chamber 11, the external air can flow out of the groove 6321 along the gap between the outer surface of the smoking product 200 and the inner wall of the heating chamber 11, then flow through the groove 6321 to the hollow region 633 of the resisting portion 63, and finally flow into the smoking product 200, as shown in an air inlet path R2 in FIG. 11. It is worth noting that a tail end of smoking product 200 is usually opened, just like a traditional cigarette. When the smoking product 200 is smoked, the external air can enter the smoking product 200 through the tail end of smoking product 200.

It should be noted that, the resisting portion 63 is configured as a hollow tubular structure. On the one hand, the external air can be guided into the hollow region 633 of the resisting portion 63, and the external air is conveyed into the smoking product 200. On the other hand, the hollow region 633 of the resisting portion 63 can be further used as an accommodating cavity to collect a small amount of condensate and smoke residues generated by the smoking product 200 during the operation of the heating assembly 100, thereby facilitating cleaning of the heating assembly 100. It can be cleaned after being removed from the heating assembly 100 via the second end cap 60.

It is easily understood that there may be one or more grooves 6321, as long as the external air can enter the hollow region 633 of the resisting portion 63 through the groove 6321. In this embodiment, a plurality of grooves 6321 are provided. The plurality of grooves 6321 surround the side wall 632 of the resisting portion 63, which facilitates the external air to enter the hollow region 633 of the resisting portion 63. It should be noted that, in other embodiments of this application, the resisting portion 63 may not be configured as the hollow tubular structure, but the resisting portion 63 is configured as a solid columnar body. At this time, the end surface 631 of the resisting portion 63 is a closed plane, and an end surface of the tail end of the smoking product 200 resists against the closed end surface of the resisting portion 63. Due to the presence of the grooves 6321, at least a portion of the end surface of the tail end of the smoking product 200 is not closed, so that the external air can enter the smoking product 200 through the grooves 6321.

An annular gap 64 is formed between the outer wall 62 and the resisting portion 63. A lower end portion of the heating pipe 50 is located in the annular gap 64. The second seal member 70 surrounds the resisting portion 63 and fills the annular gap 64. The lower end portion of the heating pipe 50 presses a surface of the second seal member 70. The second seal member 70 can be made of a flexible rubber material, such as silica gel or rubber, so that under the pressure of the heating pipe 50, the second seal member 70 can seal an assembling gap between the heating pipe 50 and the second end cap 60, to prevent the external air from entering the heating pipe 50 through this gap and then enter the cut tobacco section 220 of the smoking product 200.

In some examples, a heating element 80 is wrapped around an outer wall of the heating pipe 50. The heating element 80 may be a grid heating element. The grid heating element can be formed by weaving heating wires or by providing holes in a heating sheet. Heat generated by the heating element 80 can be transferred to the heating pipe 50, and then transferred to the smoking product 200 by the heating pipe 50. A tobacco material filling the smoking product 200 can evaporate into smoke, i.e. aerosols, at a high temperature. A user can inhale the aerosols through a suction nozzle of the smoking product 200.

It should be noted that, the heating element 80 is wrapped around the outer wall of the heating pipe 50. Then, the heat is transferred to the aerosol product 200 in the heating chamber 11 through the outer wall of the heating pipe 50. This mode is a circumferential heating mode, namely, the heating pipe 50 transfers the heat to the aerosol product 200 in the circumferential direction. In other embodiments of this application, the heating element 80 may use a central heating mode too. For example, the heating element 80 can be arranged in the heating pipe 50. The heating element 80 can be constructed as a slender heating needle. The heating needle can be in the form of a ceramic heating rod or an electromagnetic heating needle. As a suitable example, the ceramic heating rod includes a ceramic base body and a resistive heating material attached to the ceramic base body. As a suitable example, the electromagnetic heating needle uses a metal needle made of a ferromagnetic material. An induction coil is arranged on the outer wall of the heating pipe 50. When alternating current is made to the induction coil, under the action of electromagnetic induction, the electromagnetic heating needle generates heat using an eddy current effect and a hysteresis effect. When the aerosol product 200 is accommodated in the heating chamber 11, the heating needle is directly plugged into the aerosol product 200, and the heat is dissipated from the heating needle to the surrounding, thereby forming the central heating mode.

In some examples, to provide electric energy to the heating element 80, the heating assembly 100 further includes a conductive electrode 90 electrically connected to the heating element 80. An electrode hole 611 is provided on the bottom wall 61 of the second end cap 60. The conductive electrode 90 extends out of the heating assembly 100 through the electrode hole 611, to be electrically connected to an external power supply mechanism, so that the external power supply mechanism can supply power to the heating assembly 100 through the conductive electrode 90.

Another embodiment of this application further provides an aerosol generation device. The aerosol generation device includes the heating assembly 100 described in the above embodiment, and a power supply mechanism (not shown) configured to supply electric energy to the heating assembly 100. The power supply mechanism includes a battery cell (not shown), a control board (not shown), and an electric connection terminal (not shown). The electric connection terminal is electrically connected to the conductive electrode 90 of the heating assembly 100. When the aerosol generation device works, the control board can control the battery cell to supply the electric energy to the heating assembly 100 through the electric connection terminal, to heat the aerosol product 200 and generate aerosols.

Another embodiment of this application further provides an aerosol generation system. The aerosol generation system includes the above aerosol generation device and an aerosol product 200 used in conjunction with the aerosol generation device. The aerosol product 200 is constructed as being cylindrical and can be filled with solid herbaceous plants such as tobaccos or herbs. When these solid herbaceous plants are heated, active components in them can be heated to evaporate. The aerosol product 200 can be accommodated in the heating chamber 11 of the aerosol generation device. The heating assembly 100 of the aerosol generation device can heat the solid herbaceous plants in the aerosol product 200 to evaporate, thereby generating aerosols that can be inhaled by a user. The flexible clamping member 20 in the aerosol generation device can clamp the aerosol product 200, thereby stably accommodating the aerosol product 200 in the heating chamber. To ensure that the clamping force applied by the flexible clamping member 20 to the aerosol product 200 is appropriate, the hole diameter of the first through hole 241 of the flexible clamping member 20 is less than the outer diameter of the aerosol product 200 by 0.01 to 1 mm, so that when the aerosol product 200 passes through the first through hole 241, the hole wall of the first through hole 241 undergoes appropriate deformation, thereby generating an appropriate clamping force.

Finally, it should be noted that: the foregoing embodiments are merely used for describing the technical solutions of this application, but are not intended to limit this application. Under the ideas of this application, the technical features in the foregoing embodiments or different embodiments may alternatively be combined, the steps may be performed in any order, and many other changes of different aspects of this application also exists as described above, and these changes are not provided in detail for simplicity. Although this application is described in detail with reference to the foregoing embodiments, it should be appreciated by a person skilled in the art that, modifications may still be made to the technical solutions described in the foregoing embodiments, or equivalent replacements may be made to the part of the technical features; and these modifications or replacements will not cause the essence of corresponding technical solutions to depart from the scope of the technical solutions in the embodiments of this application.

1. An aerosol product heating assembly, configured to heat an aerosol product to generate aerosols, the aerosol product heating assembly comprising:
a heating chamber, configured to accommodate the aerosol product and cause the aerosol product to be heated in the heating chamber; and
a flexible clamping member, provided with an extending portion that at least partially extends into the heating chamber, the extending portion forming a first through hole in the heating chamber, the extending portion being provided with at least one second through hole adjacent to the first through hole;
wherein when the aerosol product is accommodated in the heating chamber, the aerosol product penetrates through the first through hole and is circumferentially clamped by the extending portion; and external air enters the heating chamber through the second through hole.

2. The heating assembly according to claim 1, wherein a plurality of second through holes are comprised; and the plurality of second through holes surround the first through hole.

3. The heating assembly according to claim 1, wherein:
the heating chamber is provided with an opening end for allowing the aerosol product to enter the heating chamber; and
the flexible clamping member is mounted at the opening end.

4. The heating assembly according to claim 3, wherein:
the heating assembly comprises a first end cap and a second end cap which are oppositely arranged in an axial direction, and a heating pipe supported between the first end cap and the second end cap;
the first end cap and the heating pipe are hollowed;
hollow portions of the first end cap and the heating pipe are communicated to form at least one portion of the heating chamber;
the opening end is formed by the first end cap; and
the flexible clamping member is mounted on the first end cap.

5. The heating assembly according to claim 4, wherein:
the second end cap comprises a bottom wall and a resisting portion that extends axially from the bottom wall towards the heating pipe; and
the resisting portion comprises an end surface configured to resist against the aerosol product.

6. The heating assembly according to claim 5, wherein:
the resisting portion comprises a side wall that extends axially between the end surface and the bottom wall;
at least one groove is provided in the side wall; and
the groove is configured to guide the external air entering the heating chamber into the aerosol product.

7. The heating assembly according to claim 6, wherein:
the resisting portion is configured to have a hollow region inside;
the end surface of the resisting portion is opened; and
the hollow region is configured to collect residues falling from the aerosol product.

8. The heating assembly according to claim 7, wherein the groove is communicated to the hollow region of the resisting portion.

9. The heating assembly according to claim 1, wherein a thickness of the extending portion gradually decreases in an extending direction.

10. The heating assembly according to claim 1, wherein a hole wall of the first through hole has a thickness of 0.2 to 0.4 mm.

11. The heating assembly according to claim 1, wherein a hole diameter of the first through hole is less than an outer diameter of the aerosol product by 0.01 to 1 mm.

12. An aerosol generation device comprising:
the heating assembly according to claim 1; and
a power supply mechanism configured to supply electric energy to the heating assembly.
